(19) United States
(12) Patent Application Publication
(10) Pub. No.: US 2006/0083149 A1
(43) Pub. Date: Apr. 20, 2006

(54) Protect circuit for optical disk drives

(75) Inventor: Te-Yi Chang, Taipei (TW)

Correspondence Address: G. LINK Co., LTD., PMB 174, 931 West 75th Street, Suite 137, Naperville, IL, 60565, US

(73) Assignee: BEHAVIOR Computer Tech Corp.

(21) Appl. No.: 10/966,515

(22) Filed: Oct. 18, 2004

(51) Int. Cl. G11B 7/00

(52) U.S. Cl. 369/124.01

(57) ABSTRACT

This invention relates to a protect circuit of an optical disk drive, which comprises a discharge circuit being at least connected to a first DC voltage and a ground terminal, wherein the first DC voltage and ground terminal are electrically connected to a power socket of the optical disk drive, and the discharge circuit is used to supply the electric power for the operation of the optical disk drive. If the first DC voltage and ground terminal are unplugged abnormally from the power socket, the first DC voltage and the ground terminal are connected immediately to discharge the remaining electricity of the first DC voltage in the optical disk drive.

### FIELD OF THE INVENTION

The present invention relates to a protect circuit for optical disk drives, more particularly to a protect circuit device of an optical disk drive for protecting the optical disk drive when it is abnormally unplugged and disconnected and preventing it from being affected and damaged by the remaining electric power.

### BACKGROUND OF THE INVENTION

Please refer to FIG. 1 for the structure of a prior-art optical disk drive. The prior-art optical disk drive 10 has its electric power connected to an external power supply through a power socket 103 and an optical disk drive circuit 101 inside the optical disk 10 is connected directly to the power socket 103 for reading and writing an optical disk. Since there is no protection mechanism between the optical disk drive circuit 101 and the power socket 103 connected to an external power supply to protect the optical disk drive circuit 101, therefore when the power socket 103 is abnormally disconnected from the external power supply of an operating optical disk drive 10 (for example, a user suddenly unplugs the connector), there is some electric power remaining in the optical disk drive 10 after the power disconnection. The optical disk drive circuit 101 will be damaged if such remaining electricity is not handled properly.

In view of the shortcomings of the prior-art optical disk drive as described above, the inventor of the present invention, based on years of experience in the related area and performing extensive research and development, finally invented a protect circuit device according to the present invention to prevent an operating optical disk drive from being affected and damaged by the remaining electricity when it is unplugged and disconnected from the power supply.

### SUMMARY OF THE INVENTION

The primary objective of the present invention is to provide an optical disk drive capable of preventing its being affected and damaged by the remaining electricity if the power of the optical disk drive is unplugged abnormally during its operation.

To achieve the foregoing objective, the present invention provides a protect circuit device for optical disk drives, which comprises a discharge circuit at least connected to a first DC voltage and a ground terminal; wherein the first DC voltage and the ground terminal are electrically connected to a power socket of the optical disk drive, and the discharge circuit is used to supply the electric power for the operation of the optical disk drive. If the first DC voltage and the ground terminal are unplugged abnormally from the power socket, the first DC voltage and the ground terminal are connected immediately to discharge the remaining electricity of the first DC voltage in the optical disk drive.

### BRIEF DESCRIPTION OF THE DRAWINGS

The present invention can be more fully understood by reference to the following description and accompanying drawings, in which:

FIG. 1 is a view of the structure of a prior-art optical disk drive;

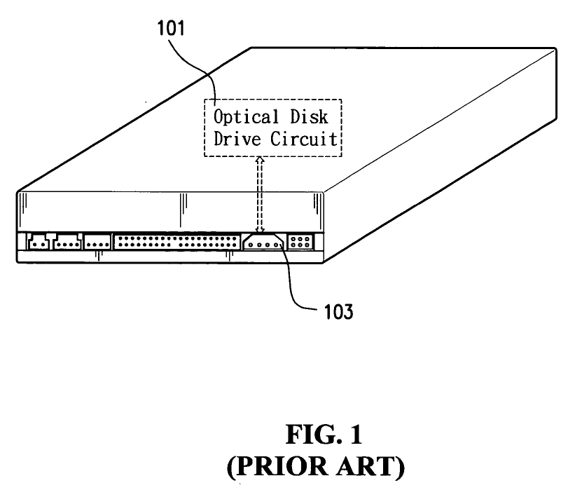

FIG. 2 is a view of the structure of an optical disk drive adopting the protect circuit of the present invention;

FIG. 3 a circuit block diagram of the protect circuit device according to the present invention;

FIG. 4 is a circuit diagram of an embodiment as depicted in FIG. 3;

FIG. 5 is a view of the waveform regarding the voltage change to the first DC voltage of an optical disk drive having a protect circuit device according to the present invention when the external power supply and power socket are unplugged directly; and

FIG. 6 is a view of the waveform regarding the voltage change to the first DC voltage of a prior-art optical disk drive when the external power supply and power socket are unplugged directly.

### DETAILED DESCRIPTION OF THE INVENTION

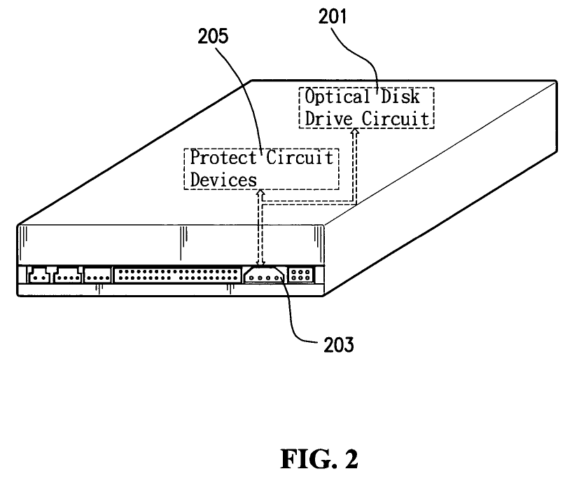

Please refer to FIG. 2 for the structure of the protect circuit device for an optical disk drive according to the present invention. The optical disk drive 20 has a protect circuit device 205 therein, and the power socket 203 is electrically connected to the protect circuit device 205 and an optical disk drive circuit 201. The internal optical disk drive is used as an example for the description, and the physical configuration of the power socket 203 is a power socket comprised of a 12V DC (12-volt direct current voltage) terminal, a 5V DC (5-volt direct current voltage) terminal, and a ground terminal. The electric power from an external power supply is supplied to the optical disk drive 20 through the power socket 203. The optical disk drive circuit 201 may adopt the prior art having the main function of reading or writing an optical disk. The protect circuit device 205 is connected to the first DC voltage 203A and the ground terminal 203B of the power socket 203. By the example given above, the protect circuit device 205 can be connected to the 12V DC terminal and the ground terminal of the power socket 203.

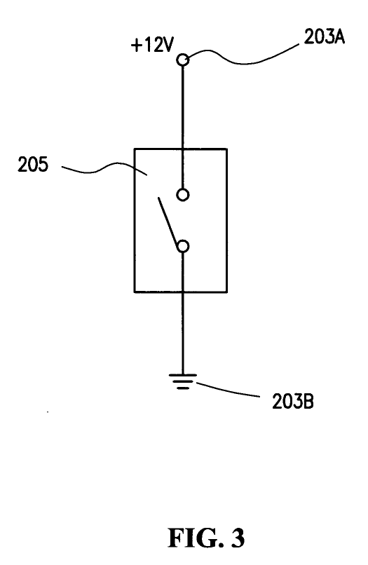

Please refer to FIG. 3 for the circuit block diagram of the protect circuit device according to the present invention. The protect circuit device 205 is connected individually to the first DC voltage 203A and the ground terminal 203B. As to the circuit implementation, the protect circuit device 205 is also known as a discharge circuit for protecting an operating optical disk drive 20. When the first DC voltage 203A and the ground terminal 203B are disconnected abnormally from the power socket 203, the protect circuit device 205 quickly connects the first DC voltage 203A with the ground terminal 203B as to quickly discharge the remaining electricity of the first DC voltage 203A in the optical disk drive 20. If a user of the optical disk drive 20 compulsorily unplugs the power socket 203 of the operating disk drive 20 directly from the external power supply, then the protect circuit device 205 immediately carries out its function by quickly connecting the 12V DC to the ground to discharge the 12V DC electric power remained in the optical disk drive 20 and will thus prevent the optical disk drive circuit 201 from being damaged by the remaining power of 12V DC power.

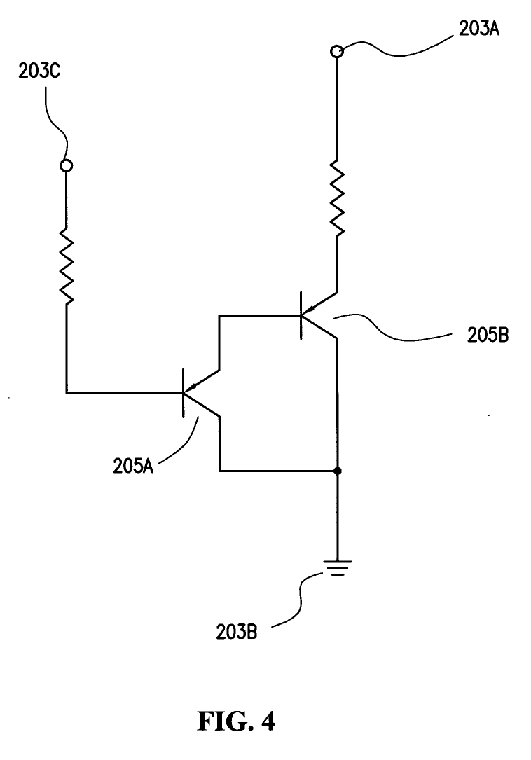

Please refer to FIG. 4 for the circuit diagram of an embodiment as depicted in FIG. 3. The protect circuit device 205 as shown in FIG. 4 is an electronic switch circuit comprised of a first transistor 205A and a second transistor 205B; wherein the second transistor 205B is connected individually to the first DC voltage 203A and the ground terminal 203B, and the first transistor 205A is connected to the second DC voltage 203C and the second transistor 205B. The first transistor 205A mainly provides a control signal to the second transistor 205B, so that when the second transistor 205B receives the control signal, it is electrically connected immediately to connect the first DC voltage 203A with the ground terminal 205B. The control signal of the first transistor 205A will be generated immediately if the power socket 203 is unplugged and disconnected directly from the external power supply. The second DC voltage 203C connected to the first transistor 205A could be 5V DC.

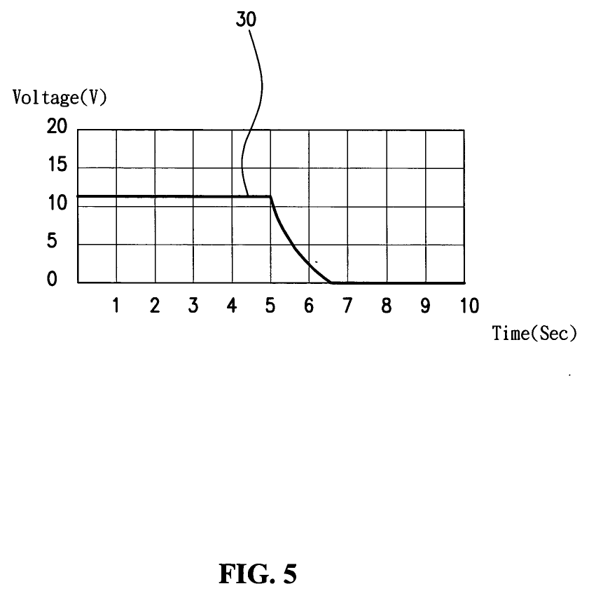

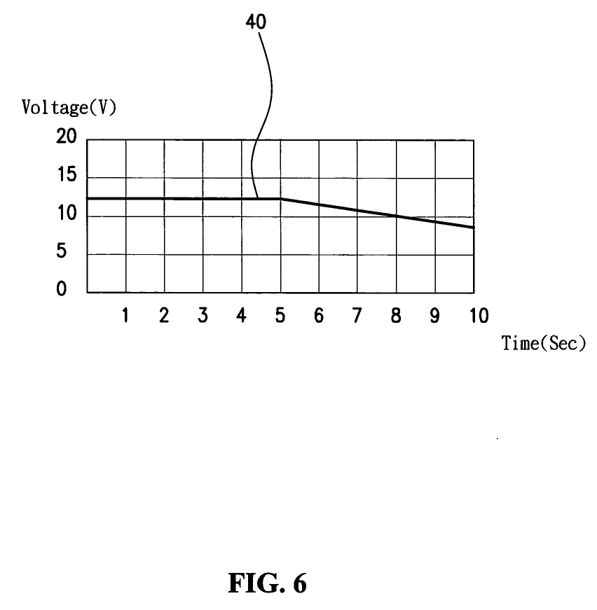

FIG. 5 shows the waveform of the voltage change of the first DC voltage when the power socket of an optical disk drive having the protect circuit device according to the present invention is unplugged from the external power supply. FIG. 6 shows the waveform of the voltage change of the first DC voltage when the power socket of a prior-art optical disk drive is unplugged from the external power supply. From the comparison between the waveform 30 as shown in FIG. 5 and the waveform 40 as shown in FIG. 6, the waveforms 30, 40 are normal before the first 5 seconds (from Second 0 to Second 5). In other words, both optical disk drives 20, 10 are operating under a normal electric power supply. Please note that for both the waveform 30 and the waveform 40, when the power socket 203 and the power socket 103 of optical disk drive 20 and the optical disk drive 10 are compulsorily unplugged and disconnected from the external power supply respectively, the voltage of the waveform 30 of the voltage change of the present invention after the fifth second will drop and approach the zero voltage quickly. While the voltage of the first DC voltage 203A according to the present invention drops and approaches zero voltage, the waveform 40 of the voltage change according to the prior art shows that the voltage of the first DC voltage is dropping slowly. Therefore, the improvement made by the present invention is very significant.

For the persons skilled in the art, it is obvious that the main reason for the voltage of the first DC voltage of the prior-art optical disk drive 10 to drop slowly as shown in FIG. 6 resides on the excessively large impedance of the electric circuit generated from the optical disk drive circuit connected to the first DC voltage. The protect circuit device 205 according to the present invention definitely overcomes the shortcoming due to such excessively large impedance.

The optical disk drive 20 having the protect circuit device 205 according to the present invention could be an internal optical disk drive or an optical disk writer, etc.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A protect circuit device for optical disk drives, comprising:
a discharge circuit, being at least connected to a first DC voltage and a ground terminal; wherein said first DC voltage and said ground terminal is electrically coupled to a power socket of said optical disk drive and said discharge circuit is used for quickly connecting said first DC voltage to said ground terminal if said first DC voltage and said ground terminal are separated abnormally from said power socket during the operation of said optical disk drive to discharge the remaining electricity of said first DC voltage in said optical disk drive.

2. The protect circuit device for optical disk drives of claim 1, wherein said first DC voltage is a DC voltage of 12 volts.

3. The protect circuit device for optical disk drives of claim 1, wherein said optical disk drive is an internal optical disk drive.

4. The protect circuit device for optical disk drives of claim 1, wherein said optical disk drive is an optical disk writer.

5. The protect circuit device for optical disk drives of claim 1, wherein said discharge circuit is an electric switch circuit comprised of a first transistor and a second transistor.

6. The protect circuit device for optical disk drives of claim 1, wherein said discharge circuit further comprises a second DC voltage.

7. The protect circuit device for optical disk drives of claim 6, wherein said second DC voltage is a DC voltage of 5 volts.
